(19) United States
(12) Patent Application Publication
(10) Pub. No.: US 2025/0081100 A1
(43) Pub. Date: Mar. 6, 2025

(54) SYSTEMS AND METHODS OF TARGET WAKE TIME SCHEDULE MANAGEMENT

(71) Applicant: Meta Platforms Technologies, LLC, Menlo Park, CA (US)

(72) Inventors: Muhammad Kumail Haider, Sunnyvale, CA (US); Guoqing Li, Cupertino, CA (US)

(73) Assignee: Meta Platforms Technologies, LLC, Menlo Park, CA (US)

(21) Appl. No.: 18/621,197

(22) Filed: Mar. 29, 2024

Related U.S. Application Data
(60) Provisional application No. 63/580,867, filed on Sep. 6, 2023.

(51) Int. Cl. H04W 52/02; H04W 84/12

(52) U.S. Cl. CPC H04W 52/0225; H04W 84/12

(57) ABSTRACT

Systems, methods, and devices for managing target wake time (TWT) schedules may include a first device of a wireless local area network (WLAN) which receives information relating to drift of a start time of a target wake time (TWT) schedule from a second device of the WLAN. The first device may modify a start time for a subsequent TWT service period, according to the information relating to the drift of the start time from the second device.

### CROSS-REFERENCE TO RELATED APPLICATIONS

This application claims the benefit of and priority to U.S. Provisional Application No. 63/580,867, filed Sep. 6, 2023, the contents of which is incorporated herein by reference in their entirety.

### FIELD OF DISCLOSURE

The present disclosure is generally related to communications, including but not limited to systems and methods for management of schedules for target wake time service periods. For example, the target wake time service periods can be adjusted to align with periodic availability, such as the periodic availability of video data, which corresponds to a refresh rate.

### BACKGROUND

Devices can enter low power states to reduce energy usage during times of inactivity. Battery operated devices may employ low power states to extend battery life, though lowering energy consumption of all devices can aid in improving efficiency of operation. For example, wireless communication devices can synchronize operational windows to reduce power usage, such as by establishing a target wake times (TWT) in a wireless fidelity (Wi-Fi) network.

Artificial reality, such as a virtual reality (VR), augmented reality (AR), or mixed reality (MR), provides immersive experience to a user. In one example, a head wearable display (HWD) can display an image of a virtual object generated by a computing device communicatively coupled to the HWD, such as over a wireless network. The network can include various peripheral or other devices.

### SUMMARY

In one aspect, this disclosure is directed to a method. The method may include receiving, by a first wireless local area network (WLAN) device (e.g., first device of a WLAN, such as AP or STA), information relating to drift of a start time of a target wake time (TWT) schedule from a second WLAN device (e.g., second device of the WLAN, such as STA or AP in communication with first device). The method may include modifying, by the first WLAN device, a start time for a subsequent TWT service period, according to the information relating to the drift of the start time from the second WLAN device (e.g., modify to be earlier or later based on information relating to drift).

In some embodiments, the first WLAN device receives the information in an announcement (e.g., announcement) of the TWT schedule from the second WLAN device. In some embodiments, the announcement includes at least one of a broadcast frame, the broadcast frame including a beacon response frame or a probe response frame, or an individually addressed frame to the first WLAN device, the individually addressed frame including an individual probe response frame or a re-association response frame. In some embodiments, the information relating to the drift may be received in a message including a TWT element indicating a start time and a wake interval of the TWT schedule. In some embodiments, the information relating to the drift may be received in a message comprising a quality of service (QoS) characteristics element (e.g., an SCS descriptor element).

In some embodiments, the first WLAN device includes at least one of an access point (AP) or a station device (STA), and wherein the second WLAN device includes the other of an AP or a STA. In some embodiments, the information relating to the drift of the start time includes a drift sign, a drift value, and an adjustment value. In some embodiments, the drift information further includes a frame rate. In some embodiments, the information relating to the drift of the start time may be carried in a TWT setup frame, which further includes one or more TWT elements.

In another aspect, this disclosure is directed to a first device. The first device may include a wireless local area network (WLAN) transceiver. The first device may include one or more processors configured to receive, via the WLAN transceiver, information relating to drift of a start time of a target wake time (TWT) schedule from a second device. The one or more processors may modify a start time for a subsequent TWT service period, according to the information relating to the drift of the start time from the second device.

In some embodiments, the first device receives the information in an announcement of the TWT schedule from the second device. In some embodiments, the announcement includes at least one of a broadcast frame, the broadcast frame including a beacon response frame or a probe response frame, or an individually addressed frame to the first WLAN device, the individually addressed frame including an individual probe response frame or a re-association response frame. In some embodiments, the information relating to the drift may be received in a message including a TWT element indicating a start time and a wake interval of the TWT schedule.

In some embodiments, the information relating to the drift may be received in a message comprising a quality of service (QoS) characteristics element. In some embodiments, the first device includes at least one of an access point (AP) or a station device (STA). The second device can include a different one of the AP or the STA. In some embodiments, the information relating to the drift of the start time comprises a drift sign, a drift value, and an adjustment value. In some embodiments, the information includes a frame rate. In some embodiments, the information relating to the drift of the start time is carried in a TWT setup frame which includes one or more TWT elements.

In another aspect, this disclosure is directed to a method. The method may include transmitting, by a first wireless local area network (WLAN) device, information relating to drift of a start time of a target wake time (TWT) schedule to a second WLAN device. The method may include modifying, by the first WLAN device, a start time for a subsequent TWT service period, according to the information relating to the drift of the start time.

In some embodiments, the information relating to the drift is transmitted in a message including a TWT element indicating a start time and a wake interval of the TWT schedule.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a timing diagram showing a wake-up/sleep schedule of a computing device utilizing TWT, according to an example implementation of the present disclosure.

FIG. 5 is a timing diagram showing an offset between data availability and a service period for multiple devices in a network environment, the offset corresponding to drift information exchanged between the multiple devices, according to an example implementation of the present disclosure.

FIG. 6 is another timing diagram showing an offset between data availability and a service period for multiple devices in a network environment, the offset corresponding to drift information exchanged between the multiple devices, according to an example implementation of the present disclosure.

FIG. 7 is a diagram showing an example field to convey drift information between various networked devices, according to an example implementation of the present disclosure.

FIG. 8 is a diagram showing an information element to convey drift information between various networked devices, according to an example implementation of the present disclosure.

FIG. 9 is a block diagram of a computing environment, according to an example implementation of the present disclosure.

FIG. 10 is an interaction diagram showing a method of drift adjustments, according to an example implementation of the present disclosure.

FIG. 11 is a flowchart showing a method of drift adjustment, according to an example implementation of the present disclosure.

FIG. 12 is another flowchart showing a method of drift adjustment, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

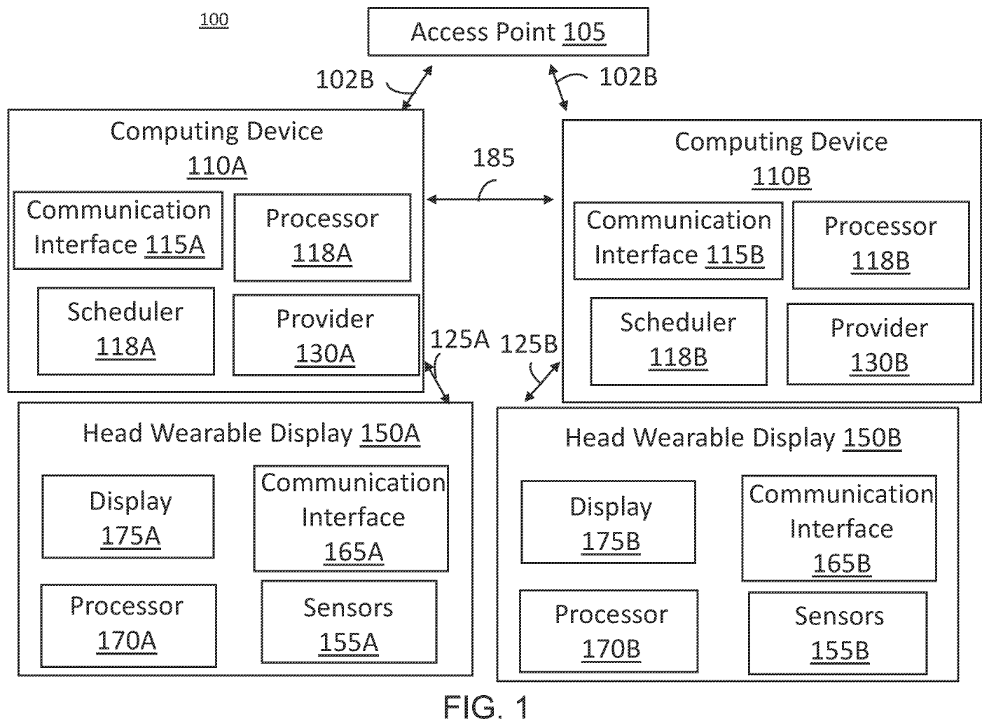

FIG. 1 is a block diagram of an example artificial reality system environment. FIG. 1 provides an example environment in which devices may communicate traffic streams with different latency sensitivities/requirements. In some embodiments, the artificial reality system environment 100 includes an access point (AP) 105, one or more head wearable displays (HWD) 150 (e.g., HWD 150A, 150B) worn by a user, and one or more computing devices 110 (computing devices 110A, 110B) providing content of artificial reality to the HWDs 150.

The access point 105 may be a router or any network device allowing one or more computing devices 110 and/or one or more HWDs 150 to access a network (e.g., the Internet). The access point 105 may be replaced by any communication device (cell site). A HWD may be referred to as, include, or be part of a head mounted display (HMD), head mounted device (HMD), head wearable device (HWD), head worn display (HWD), or head worn device (HWD). In one aspect, the HWD 150 may include various sensors to detect a location, an orientation, and/or a gaze direction of the user wearing the HWD 150, and provide the detected location, orientation and/or gaze direction to the computing device 110 through a wired or wireless connection. The HWD 150 may also identify objects (e.g., body, hand face).

In some embodiments, the computing devices 110A, 110B communicate with the access point 105 through communication links 102A, 102B (e.g., interlinks), respectively. In some embodiments, the computing device 110A may communicate with the HWD 150A through a communication link 125A (e.g., intralink), and the computing device 110B may communicate with the HWD 150B through a wireless link 125B (e.g., intralink).

The computing device 110 may be a computing device or a mobile device that can retrieve content from the access point 105, and can provide image data of artificial reality to a corresponding HWD 150. Each HWD 150 may present the image of the artificial reality to a user according to the image data.

The computing device 110 may determine a view within the space of the artificial reality corresponding to the detected location, orientation and/or the gaze direction, and generate an image depicting the determined view detected by the HWD 150s. The computing device 110 may also receive one or more user inputs and modify the image according to the user inputs. The computing device 110 may provide the image to the HWD 150 for rendering. The image of the space of the artificial reality corresponding to the user's view can be presented to the user.

In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the computing device 110 may be performed by the HWD 150, and/or some of the functionality of the HWD 150 may be performed by the computing device 110. In some embodiments, the computing device 110 is integrated as part of the HWD 150.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155 (e.g., sensors 155A, 155B) including eye trackers and hand trackers for instance, a communication interface 165 (e.g., communication interface 165A, 165B), an electronic display 175, and a processor 170 (e.g., processor 170A, 170B). These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, hand trackers, eye trackers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the sensors 155 may also include eye trackers with electronic components or a combination of electronic components and software components that determine a gaze direction of the user of the HWD 150. In other embodiments, the eye trackers may be a component separate from sensors 155. In some embodiments, the HWD 150, the computing device 110 or a combination may incorporate the gaze direction of the user of the HWD 150 to generate image data for artificial reality. In some embodiments, the eye trackers (as part of the sensors 155, for instance) include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers may determine that the gaze direction of the user is 20 degrees from the reference direction. In some embodiments, a user of the HWD 150 can configure the HWD 150 (e.g., via user settings) to enable or disable the eye trackers as part of the sensors 155. In some embodiments, a user of the HWD 150 is prompted to enable or disable the eye trackers as part of the sensor 155 configuration.

In some embodiments, the sensors 155 include the hand tracker, which includes an electronic component or a combination of an electronic component and a software component that tracks a hand of the user. In other embodiments, the hand tracker may be a component separate from sensors 155. In some embodiments, the hand tracker includes or is coupled to an imaging sensor (e.g., camera) and an image processor that can detect a shape, a location and/or an orientation of the hand. The hand tracker may generate hand tracking measurements indicating the detected shape, location and/or orientation of the hand.

In some embodiments, the communication interfaces 165 (e.g., communication interface 165A, 165B) of the corresponding HWDs 150 (e.g., HWD 150A, 150B) and/or communication interfaces 115 (e.g., communication interface 115A, 115B) of the corresponding computing devices (e.g., computing device 110A, 110B) include an electronic component or a combination of an electronic component and a software component that is used for communication.

The communication interface 165 may communicate with a communication interface 115 of the computing device 110 through an intralink communication link 125 (e.g., communication link 125A, 125B). The communication interface 165 may transmit to the computing device 110 sensor measurements indicating the determined location of the HWD 150, orientation of the HWD 150, the determined gaze direction of the user, and/or hand tracking measurements. For example, the computing device 110 may receive sensor measurements indicating location and the gaze direction of the user of the HWD 150 and/or hand tracking measurements and provide the image data to the HWD 150 for presentation of the artificial reality, for example, through the wireless link 125 (e.g., intralink). For example, the communication interface 115 may transmit to the HWD 150 data describing an image to be rendered. The communication interface 165 may receive from the computing device 110 sensor measurements indicating or corresponding to an image to be rendered. In some embodiments, the HWD 150 may communicate with the access point 105.

Similarly, the communication interface 115 (e.g., communication interface 115A, 115B) of the computing devices 110 may communicate with the access point 105 through a communication link 102 (e.g., communication link 102A, 102B). In certain embodiments, the computing device 110 may be considered a soft access point (e.g., a hotspot device). Through the communication link 102 (e.g., interlink), the communication interface 115 may transmit and receive from the access point 105 AR/VR content. The communication interface 115 of the computing device 110 may also communicate with communication interface 115 of a different computing device 110 through communication link 185. As described herein, the communication interface 115 may be a counterpart component to the communication interface 165 to communicate with a communication interface 115 of the computing device 110 through a communication link (e.g., USB cable, a wireless link).

The communication interfaces 115 and 165 may receive and/or transmit information indicating a communication link (e.g., channel, timing) between the devices (e.g., between the computing devices 110A and 110B across communication link 185, between the HWD 150A and computing device 110A across communication link 125). According to the information indicating the communication link, the devices may coordinate or schedule operations to avoid interference or collisions.

The communication link may be a wireless link, a wired link, or both. In some embodiments, the communication interface 165/115 includes or is embodied as a transceiver for transmitting and receiving data through a wireless link. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the computing device 110 and the head wearable display 150 are implemented on a single system, the communication interface 165 may communicate with the computing device 110 through a bus connection or a conductive trace.

Using the communication interface, the computing device 110 (or HWD 150, or AP 105) may coordinate operations on links 102, 185 or 125 to reduce collisions or interferences by scheduling communication. For example, the computing device 110 may coordinate communication between the computing device 110 and the HWD 150 using communication link 125. Data (e.g., a traffic stream) may flow in a direction on link 125. For example, the computing device 110 may communicate using a downlink (DL) communication to the HWD 150 and the HWD 150 may communicate using an uplink (UL) communication to the computing device 110. In some implementations, the computing device 110 may transmit a beacon frame periodically to announce/advertise a presence of a wireless link between the computing device 110 and the HWD 150 (or between HWDs 150A and 150B). In an implementation, the HWD 150 may monitor for or receive the beacon frame from the computing device 110, and can schedule communication with the HWD 150 (e.g., using the information in the beacon frame, such as an offset value) to avoid collision or interference with communication between the computing device 110 and/or HWD 150 and other devices.

In some embodiments, the processor 170 may include an image renderer, for instance, which includes an electronic component or a combination of an electronic component and a software component that generates one or more images for display, for example, according to a change in view of the space of the artificial reality. In some embodiments, the image renderer is implemented as processor 170 (or a graphical processing unit (GPU), one or more central processing unit (CPUs), or a combination of them) that executes instructions to perform various functions described herein. In other embodiments, the image renderer may be a component separate from processor 170. The image renderer may receive, through the communication interface 165, data describing an image to be rendered, and render the image through the electronic display 175. In some embodiments, the data from the computing device 110 may be encoded, and the image renderer may decode the data to generate and render the image. In one aspect, the image renderer receives the encoded image from the computing device 110, and decodes the encoded image, such that a communication bandwidth between the computing device 110 and the HWD 150 can be reduced.

In some embodiments, the image renderer receives, from the computing device, 110 additional data including object information indicating virtual objects in the artificial reality space and depth information indicating depth (or distances from the HWD 150) of the virtual objects. Accordingly, the image renderer may receive from the computing device 110 object information and/or depth information. The image renderer may also receive updated sensor measurements from the sensors 155. The process of detecting, by the HWD 150, the location and the orientation of the HWD 150 and/or the gaze direction of the user wearing the HWD 150, and generating and transmitting, by the computing device 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer may generate a small portion (e.g., 10%) of an image corresponding to an updated view within the artificial reality according to the updated sensor measurements, and append the portion to the image in the image data from the computing device 110 through reprojection. The image renderer may perform shading and/or blending on the appended edges. Hence, without recreating the image of the artificial reality according to the updated sensor measurements, the image renderer can generate the image of the artificial reality.

In other implementations, the image renderer generates one or more images through a shading process and a reprojection process when an image from the computing device 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the processor 170 (e.g., image renderer).

In some embodiments, the HWD 150 may include a lens to allow the user to see the display 175 in a close proximity. The lens may be a mechanical component that alters received light from the electronic display 175. The lens may magnify the light from the electronic display 175, and correct for optical error associated with the light. The lens may be a Fresnel lens, a convex lens, a concave lens, a filter, or any suitable optical component that alters the light from the electronic display 175. Through the lens, light from the electronic display 175 can reach the pupils, such that the user can see the image displayed by the electronic display 175, despite the close proximity of the electronic display 175 to the eyes.

In some embodiments, the processor 170 performs compensation to compensate for any distortions or aberrations. In some embodiments, a compensator may be a device separate from the processor 170. The compensator includes an electronic component or a combination of an electronic component and a software component that performs compensation. In one aspect, the lens introduces optical aberrations such as a chromatic aberration, a pin-cushion distortion, barrel distortion, etc. The compensator may determine a compensation (e.g., predistortion) to apply to the image to be rendered from the image renderer to compensate for the distortions caused by the lens, and apply the determined compensation to the image from the image renderer. The compensator may provide the predistorted image to the electronic display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a communication interface 115, a processor 118, and a content provider 130 (e.g., content provider 130A, 130B). These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view.

The processors 118, 170 includes or is embodied as one or more central processing units, graphics processing units, image processors, or any processors for generating images of the artificial reality. In some embodiments, the processors 118, 170 may configure or cause the communication interfaces 115, 165 to toggle, transition, cycle or switch between a sleep mode and a wake up mode. In the wake up mode, the processor 118 may enable the communication interface 115 and the processor 170 may enable the communication interface 165, such that the communication interfaces 115, 165 may exchange data. In the sleep mode, the processor 118 may disable the wireless interface 115 and the processor 170 may disable (e.g., may implement low power or reduced operation in) the communication interface 165, such that the communication interfaces 115, 165 may not consume power, or may reduce power consumption.

The processors 118, 170 may schedule the communication interfaces 115, 165 to switch between the sleep mode and the wake up mode periodically every frame time (e.g., 11 ms or 16 ms). For example, the communication interfaces 115, 165 may operate in the wake up mode for 2 ms of the frame time, and the communication interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced or minimized.

In some embodiments, the processors 118, 170 may configure or cause the communication interfaces 115, 165 to resume communication based on stored information indicating communication between the computing device 110 and the HWD 150. In the wake up mode, the processors 118, 170 may generate and store information (e.g., channel, timing) of the communication between the computing device 110 and the HWD 150. The processors 118, 170 may schedule the communication interfaces 115, 165 to enter a subsequent wake up mode according to timing of the previous communication indicated by the stored information. For example, the communication interfaces 115, 165 may predict/determine when to enter the subsequent wake up mode, according to timing of the previous wake up mode, and can schedule to enter the subsequent wake up mode at the predicted time. After generating and storing the information and scheduling the subsequent wake up mode, the processors 118, 170 may configure or cause the wireless interfaces 115, 165 to enter the sleep mode. When entering the wake up mode, the processors 118, 170 may cause or configure the communication interfaces 115, 165 to resume communication via the channel or frequency band of the previous communication indicated by the stored information. Accordingly, the communication interfaces 115, in 165 entering the wake up mode from the sleep mode may resume communication, while bypassing a scan procedure to search for available channels and/or performing handshake or authentication. Bypassing the scan procedure allows extension of a duration of the communication interfaces 115, 165 operating in the sleep mode, such that the computing device 110 and the HWD 150 can reduce power consumption.

In some embodiments, the computing devices 110A, 110B may coordinate operations to reduce collisions or interferences. In one approach, the computing device 110A may transmit a beacon frame periodically to announce/advertise a presence of a wireless link 125A between the computing device 110A and the HWD 150A and can coordinate the communication between the computing device 110A and the HWD 150A. The computing device 110B may monitor for or receive the beacon frame from the computing device 110A, and can schedule communication with the HWD 150B (e.g., using information in the beacon frame, such as an offset value) to avoid collision or interference with communication between the computing device 110A and the HWD 150A. For example, the computing device 110B may schedule the computing device 110B and the HWD 150B to enter a wake up mode, when the computing device 110A and the HWD 150A operate in the sleep mode. For example, the computing device 110B may schedule the computing device 110B and the HWD 150B to enter a sleep up mode, when the computing device 110A and the HWD 150A operate in the wake up mode. Accordingly, multiple computing devices 110 and HWDs 150 in proximity (e.g., within 20 ft) may coexist and operate with reduced interference.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space. The content provider 130 may encode the image data describing the image, and can transmit the encoded data to the HWD 150. In some embodiments, the content provider generates and provides the image data to the HWD 150 periodically (e.g., every 11 ms or 16 ms).

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

In some embodiments, a scheduler 118 (e.g., scheduler 118A of the computing device 118A and/or scheduler 118B of the computing device 110B) may request rTWT to transmit latency sensitive traffic using P2P communication. The AP 105 and scheduler 118 of the computing devices 110 may negotiate (e.g., perform a handshake process) and may establish a membership of a restricted TWT schedule. In some embodiments, when the AP 105 and the scheduler 118 are negotiating, the AP 105 may be considered a restricted TWT scheduling AP and the computing devices 110 may be considered a restricted TWT scheduled STA.

In some embodiments, the HWD 150 may request to send P2P traffic to the computing device 110. Accordingly, the HWD 150 may be considered the TWT requesting STA (e.g., the TWT STA that requests the TWT agreement), and the computing device 110 may be considered TWT responding STA (e.g., the TWT STA that respond to the TWT request). The communication link 125 between the computing devices 110 and the HWDs 150 may be a P2P link (e.g., a link used for transmission between two non-AP devices). The communication link 102 between the computing devices 110 and the AP 105 may be any channel or other type of link. In some configurations, the HWD 150 may move/become out of range from the access point 105. In other embodiments, the computing device 110 may request to send P2P traffic to the HWD 150 such that the computing device 110 is considered the TWT requesting STA and the HWD 150 is the TWT responding STA.

The schedulers 118 of the computing devices 110 may schedule communication between the computing device(s) 110 and the HWD(s) 150 with the AP 105 such that the communication between the computing device(s) 110 and HWD(s) 150 is protected. The computing device(s) 110 may initiate such protected P2P communication with the HWD(s) 150 by indicating, to the AP 105, that the computing device(s) 110 wish to schedule P2P communication in rTWT service periods (SPs). The scheduler 118 of the computing device(s) may schedule (or negotiate) the requested rTWT SP(s). The scheduler 118 of the computing device(s) may also indicate if the SP(s) are requested only for P2P communication (as compared to mixed P2P communication and non-P2P communication).

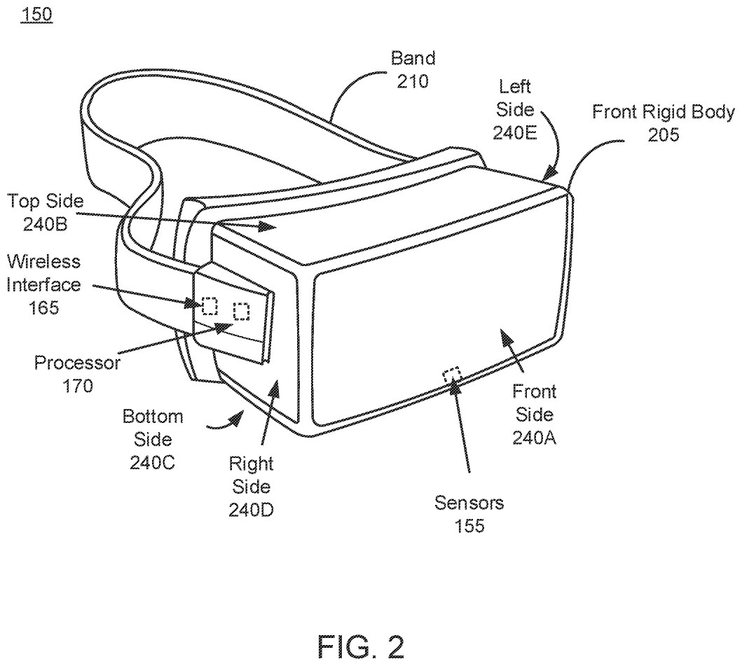

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens (not shown in FIG. 2), the sensors 155, the eye trackers the communication interface 165, and the processor 170. In the embodiment shown by FIG. 2, the sensors 155 are located within the front rigid body 205, and may not be visible to the user. In other embodiments, the HWD 150 has a different configuration than shown in FIG. 2. For example, the processor 170, the eye trackers, and/or the sensors 155 may be in different locations than shown in FIG. 2.

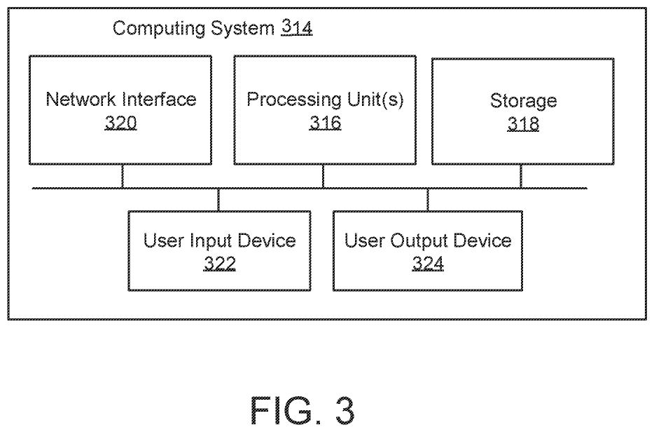

Various operations described herein can be implemented on computer systems. FIG. 3 shows a block diagram of a representative computing system 314 usable to implement the present disclosure. In some embodiments, the computing device 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

FIGS. 1-3 illustrate devices that communicate traffic streams, some of which may be latency sensitive (e.g., those carrying periodic AR/VR information/content, such as according to a frame refresh rate). As described herein, the periodic operation of TWT benefits communication of periodic traffic (e.g., latency sensitive traffic) by predictably communicating the periodic traffic.

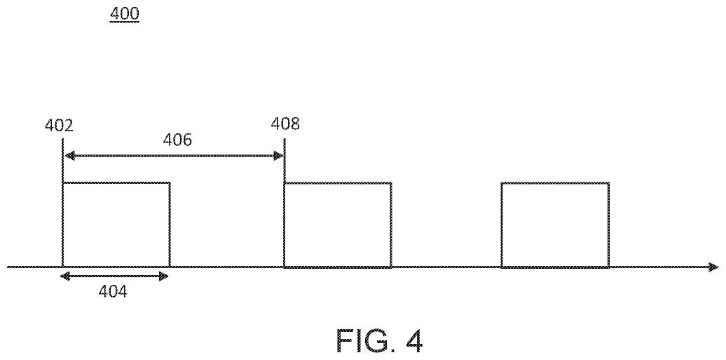

Referring generally to FIG. 4-FIG. 12, the systems and methods described herein may manage target wake time scheduling. Energy saving may be desirable in many devices due to environmental, battery life, or thermal concerns, including various devices of an AR/VR context. Such devices can include stations (STAs), and access points (APs), including a mobile AP (“hotspot”), Wi-Fi direct group owner (GO), or a device configured to alternatively operate as an AP and/or an STA at a given instance. For example, the operating time of a head mounted device (HMD) may be limited by a battery life or a thermal constraint, such that the HMD can opportunistically enter a sleep state (at least for a transceiver) to reduce energy usage and thermal loads. However, managing network latency along with sleep states can prove challenging. Latency sensitive traffic that is not prioritized (or protected) may degrade a user experience. For example, in an AR/VR context, latency between a movement of a user wearing an HMD or related device and an image corresponding to the user movement and displayed to the user using the HMD device may cause judder, resulting in motion sickness.

A Target Wake Time (TWT) is a mechanism where a set of service periods (SPs) are defined and shared between devices to reduce medium contention and improve the power efficiency of network devices. The TWT reduces energy consumption of the devices by limiting the awake time and associated power consumption of the devices. For example, the first device can wake up periodically based on the TWT. During the SP, a device may be in an awake state (e.g., its wireless communication module/interface is in a fully powered-up, ready, or wake state) and is able to transmit and/or receive. Outside of the SP, the device the device may not remain awake (e.g., its wireless communication module/interface is in a powered-down, low power, or sleep state), which may reduce a power use or a thermal load of the first device. In addition to or instead of the sleep state, a device can communicate with other devices or on other networks.

The TWT can be agreed/negotiated upon by devices (e.g., access points (APs) and/or stations (STAs)), and/or specified/configured by one device (e.g., an AP). For example, each SP can be established on a peer to peer basis as individual TWT (iTWT), or on an 1-to-n basis as broadcast TWT (bTWT), between a TWT scheduling devices and one or more TWT scheduled devices. In some embodiments, TWTs may further be communicated between adjacent basic service sets (BSS) to avoid medium contention. Scheduling between or within BSS, can avoid contention and reduce latency, such as latency of virtual objects included in video frames transmitted from a computing device to a head mounted device (HMD). Some TWT may be established as a restricted TWT (R-TWT). The SP of a R-TWT may be intended or limited for certain traffic identifiers, such as identifiers for latency sensitive traffic (e.g., video data).

Streams of traffic may be characterized by different types of traffic. For instance, an application may be characterized by latency sensitive traffic (e.g., video/voice (VI/VO), real time interactive applications, and the like) or regular traffic (e.g., best effort/background applications (BE/BK)). Latency sensitive traffic may be identifiable, in part, based on its bursty nature (e.g., periodic bursts of traffic), in some embodiments. For instance, video display traffic may be driven by a refresh rate of 60 Hz, 72 Hz, 90 Hz, or 120 Hz, where bursts of frame data appear at regular interval (e.g., every 13.888 . . . ms at 72 Hz). An application and/or device may have combinations of traffic types (e.g., latency sensitive traffic and non-latency sensitive traffic). Further, each stream of traffic for the application and/or device may be more or less spontaneous and/or aperiodic as compared to the other streams of traffic for the application and/or device. Accordingly, traffic may vary according to applications and/or channel rate dynamics.

The periodicity of the SPs can be configured for the communication of latency sensitive data. However, the latency sensitivity data may be of a periodicity which is not aligned with an SP interval. For example, an SP interval can be scheduled according to an integer number of microseconds and a periodicity of data availability may not align to integer boundaries (e.g., 60 Hz corresponds to 16,666⅔ microseconds (μs); 75 Hz corresponds to 13,333⅓ μs; 90 Hz corresponds to 11,111 1/9 μs). Thus, if the fractional remainder is truncated, rounded, or otherwise approximated, a drift may form between data availability (e.g., frame generation) and the SP scheduled for networked devices. For example, assuming an SP interval granularity of 1 μs and arithmetic rounding, after 1 cycle, an offset between a scheduled SP and an availability of data will lag by ⅓ μs at 60 Hz. An analogous offset will lead by ⅓ μs at 75 Hz and by 1/9 μs at 90 Hz. After one second, such offsets can extend to 20 μs, 25 μs, and 8.33 μs, respectively. After one minute, such offsets can extend to 1.2 ms, 1.5 ms, and 0.75 ms. Such offsets would be correspondingly larger for millisecond-scale granularity, as in the case of certain broadcast TWT scheduled according to time units (TU) of 1024 μs (e.g., could exceed a one second offset after one minute).

Where the availability of data lags the SP start time, the SP may commence prior to an availability of data. Consequently, power efficiency may be adversely affected as both a sending and receiving device sit idle awaiting the data availability. Moreover, the effective time for the SP may be reduced (e.g., a 3 ms SP for which data is not available in the first 600 μs is effectively truncated by 20%). In some instances, a portion of information intended for transmission during a SP may exceed the duration of the truncated SP, deferring a portion of data to a subsequent SP, incurring additional latency. Conversely, where the availability of data leads the SP start time, information may accumulate in queues prior to a start of a service period. Consequently, additional latency may be incurred until the start of the SP. In some instances, the accumulation of the queue data can exceed a queue capacity resulting in buffer overflow.

Although updates to correct an alignment of data with SP are possible, such communications may further congest a medium, particularly where many devices of a network implement TWT (e.g., devices at an adjoining SP which may be impacted by an adjustment to a TWT for frame data). Further, scaling such communications to many devices of a BSS (and, potentially, to nearby BSS, in the case of networks implementing spatial re-use strategies) can prove impracticable without further congesting a medium or increasing device power use from the additional associated messaging. For example, providing a message to realign a frame for every SP (of every three SP, nine AP, etc.) can substantially increase a transmit power of an associated device.

According to the present disclosure, a device can provide an indication of drift to adjust a SP start time. For example, where a TWT (e.g., R-TWT) is intended to a correspond to video data according to a fixed frame rate, a device can provide an indication corresponding to the frame rate. Such an indication can include the frame rate itself or an amount of drift per period. The period can refer to a temporal period (e.g., microseconds or milliseconds), or a number of SPs/frames. In some embodiments, either of the amount of an adjustment or the amount of the drift can be predetermined such that upon a provision of one value, a receiving device can determine a relationship therebetween, and make an adjustment to an SP start time to reduce (e.g., eliminate) the offset. For example, according to a provision of an offset for 20 μs after one second for the 60 Hz data discussed above, the receiving unit can determine that an adjustment to eliminate an offset should be 10 μs after 500 mS, or 40 μs after 2 seconds. The receiving unit can adjust the start time at a regular interval (e.g., every frame, every three frames, every nine frames, or every second) responsive to receipt of such information.

FIG. 4 is a timing diagram 400 showing a wake-up/sleep schedule of a computing device utilizing TWT, according to an example implementation of the present disclosure. The TWT start time is indicated by the computing device 110 (e.g., a portion of its relevant modules/circuitry) waking up at 402. The computing device 110 may wake up for a duration 404 defined by a SP. After the SP duration 404, the computing device 110 may enter a sleep state until the next TWT start time at 408. The interval of time between TWT start time 402 and TWT start time 408 may be considered the SP interval 406. The communication and/or negotiation of the duration 404 between devices can lower energy use (e.g., wherein a device can enter a sleep state between durations 404), and improve latency/network congestion (e.g., by scheduling restricted time periods for particular latency sensitive data).

A TWT schedule may be communicated and/or negotiated using broadcast TWT (bTWT) and/or individual TWT (iTWT) signaling. In some embodiments, the TWT schedule for an iTWT can specify the SP interval 406 according to an integer number of microseconds. In some embodiments, the TWT schedule for a bTWT can specify the SP interval 406 according to an integer number of time units (TU), each consisting of 1024 microseconds (ps). TWT schedule information may be communicated to particular (individual) devices using a mode such as a Network Allocation Vector (NAV) to protect the medium access of TWT SPs. In contrast, to signal bTWT, in some embodiments, a device (such as AP 105) may schedule TWT SPs with other devices (e.g., computing devices 110 and/or HWDs 150) and may share schedule information in beacon frames and/or probe response frames. Sharing schedule information using bTWT may reduce overhead (e.g., negotiation overhead) as compared to the overhead used when sharing information using iTWT.

In some instances, the TWT schedule for the SPs may not align with an availability of data. For example, in the case of a TWT for video content for provision to a HWD 150 according to a 60 Hz signal, a first SP will be offset from an availability of data by one third of the granularity of the defined SP (one TU or one ps). After one second of operation, such an offset can extend to twenty times the granularity. For an iTWT scheduled according to μS granularity, such an offset is 20 μS. For a bTWT scheduled according to TU granularity, such an offset may exceed 20 mS.

Although various references to an offset relating to video frame data are provided herein, such illustrative examples are not intended to be limiting. Sensor networks, network synchronization tasks, or telemetry data may also provide bursty data according to a periodic schedule. Moreover, an offset can correspond to other drift sources such as an oscillator on a sending or receiving device which exhibits drift. The drift can correspond to a temporal resolution mismatch. For example, a TWT duration may be specified according to an integer time period (e.g., milliseconds or microseconds), and relevant information may include non-integer values. In some embodiments, the drift can correspond to temperature variation, crystal aging, voltage variation, manufacturing variability, network time protocol latency, etc.

The TWT mechanism may also be used in peer-to-peer (P2P) communication. For example, TWT may be defined for tunneled direct link setup (TDLS) pairs (e.g., non-AP STAs), soft APs (such as computing devices 110) and STAs (such as HWD 150), and/or peer-to-peer group owners (GO) and group clients (GC). For instance, a TDLS pair of devices (e.g., HWD 150 and computing device 110) can request TWT membership for its latency sensitive traffic over a channel. In another example, a group owner (GO), such as a computing device 110, may request TWT membership for latency sensitive traffic over the P2P link. Periodic traffic may be provided over any of the links, wherein the systems and methods of the present disclosure can be employed to communicate—and correct for—drift associated with such periodic traffic.

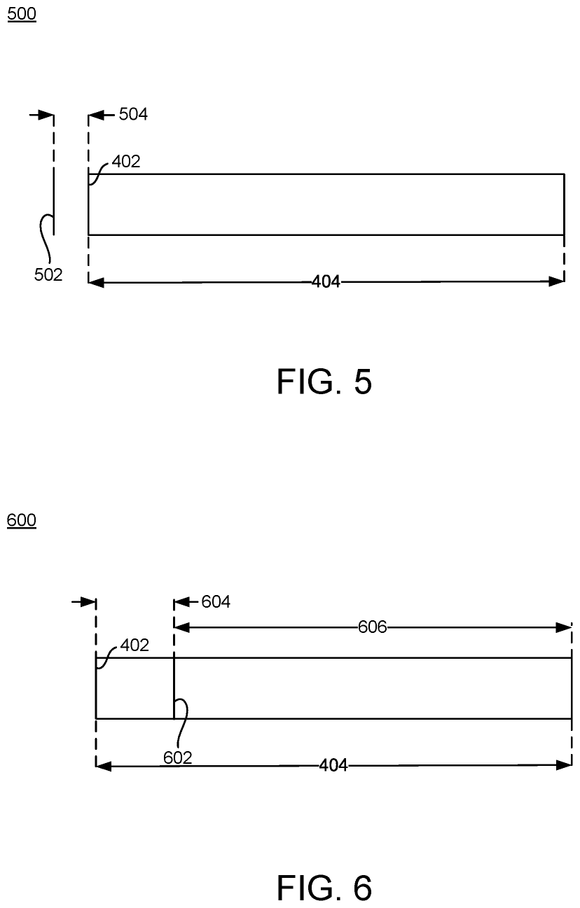

Referring now to FIG. 5, a timing diagram 500 showing an offset 504 between an availability of data 502 and a TWT start time 402 for a SP is provided, according to an example implementation of the present disclosure. The SP may be shared across multiple devices in a network environment. Multiple devices may be configured to exchange drift information corresponding to the offset 504. As depicted, the availability of data 502 leads the SP such that, while awaiting the start time 402 for the SP, latency is incurred. As described in greater detail below, the systems and methods described herein may be configured to modify/adjust/adapt the TWT schedule, based on or according to the determined corresponding offset 504.

In some embodiments, the offset 504 can accumulate between a TWT scheduling device and a TWT scheduled device. The offset 504 can accumulate across one or more SP prior to an adjustment. In some embodiments, the depicted offset 504 can represent an un-compensated value that is compensated at a sending and/or receiving device (e.g., an adjustment may be implemented to counter the offset 504, by a device sending the periodic data and receiving the periodic data). In some embodiments, the offset 504 can develop across multiple SPs. For example, the adjustment may be performed following a fixed period, such as a fixed time period or a fixed number of SPs. In some embodiments, the adjustment is equal to the offset 504 such that the availability of data 502 coincides with the TWT start time 402. In some embodiments, the adjustment may be somewhat greater or lesser than the offset 504, as the case of an offset 504 which is itself not divisible by an integer number of microseconds (e.g., corresponding to a 90 Hz signal, where an adjustment of 8 μs may be selected to reduce an offset 504 of 8⅓ μs after one second). In some embodiments, the one or more receiving devices may be configured to adjust the start time of the SP by a non-integer number of microseconds, such as 8.3, 8.33 or 8⅓ μs (e.g., in the case of an adjustment implemented for each SP).

The start time 402, duration 404, and other aspects of a SP may be common to the multiple networked devices (e.g., including a STA device and an AP 105 device). For example, the duration 404 may be defined according to a TWT setup, in milliseconds or microseconds. However, an offset 504 between the respective SP can develop according to various drift sources. Thus, the various network devices may adjust their SP according to the offset 504. The drift information can be communicated to any number of networked devices (e.g., to all basic service sets (BSS) of a network, or all devices configured to receive the frame data). In some embodiments, one or more network devices can adjust another TWT SP based on an adjustment to the depicted SP interval.

Referring now to FIG. 6, with continued reference to FIG. 5, another timing diagram 600 showing an offset between data availability and a service period for multiple devices in a network environment is provided. The offset corresponds to drift information exchanged between the multiple devices, according to an example implementation of the present disclosure. As for FIG. 5, the SP is shared across multiple devices in a network environment, the multiple devices configured to exchange drift information corresponding to the offset 504. As depicted, the availability of data 602 lags the start of the SP such that, after the start time 402 for the SP, transceivers for one or more devices may be in an active state without communicating latency sensitive information (e.g., due to the availability of data 602 lagging the start time 402), which may adversely impact power efficiency and contribute to an offset 604. Moreover, an effective duration 606 for the SP is reduced, relative to the SP duration 404, which may adversely impact throughput efficiency. Similar to with respect to FIG. 5, and as described in greater detail below, the systems and methods described herein may be configured to modify/adjust/adapt the TWT schedule, based on or according to the determined corresponding offset 604.

One or more network devices can effect/make/implement an adjustment to a start time 402 of the SP to reduce or eliminate the offset 604. For example, the adjustments of FIG. 5 and FIG. 6 can include an indication of a sign, such a sign bit of the offset 504, 604, a sign bit of the adjustment (opposite the sign of the offset), and/or according to a predefined protocol. The predefined protocol can include arithmetic rounding. For example, upon a receipt of a frame rate of 60 Hz, an embodiment configured to adjust the SP start time 402 for each SP can bring forward the start time 402 by ⅓ uS (or TU), responsive to a determination that arithmetic rounding of the interval will cause the availability of data 602 to extend beyond the SP start time 402. Such an adjustment can be performed for every SP, every N number of SPs, every SP corresponding to an integer adjustment (e.g., every 3 SP, for the 60 Hz signal), and/or over a predefined or communicated interval, some examples of which are provided below.

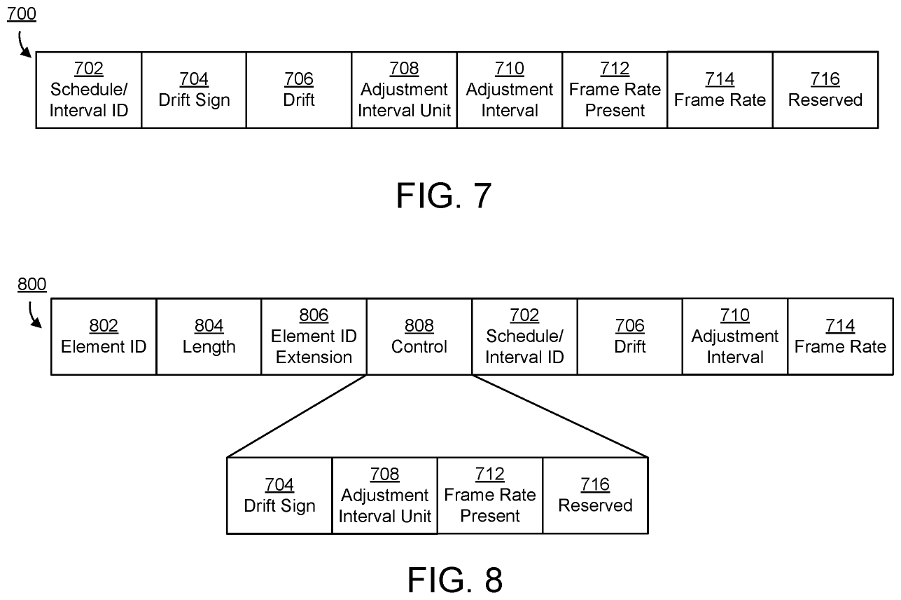

FIG. 7 is a diagram showing an example field 700 to convey drift information between network connected devices, according to an example implementation of the present disclosure. The field 700 can include any of various sub-fields including a schedule/interval ID subfield 702, drift sign subfield 704, drift subfield 706, adjustment interval unit subfield 708, frame rate present indication subfield 712, frame rate subfield 714, and a reserved subfield 716, reserved for additional related data. The particular organization of the subfields, as depicted herein, is merely illustrative and is not intended to be limiting. For example, a relative location, number of bits, or other fields relationships can vary from the illustrated embodiment of FIG. 7. For example, a second illustrative embodiment is depicted hereinafter, at to FIG. 8.

The schedule/interval ID subfield 702 can indicate/include/identify a schedule or traffic profile defined in the field 700. In some embodiments, the subfield may be an 8-bit subfield. The schedule/interval ID subfield 702 values may vary according to a particular implementation. For example, in the case of an iTWT, the subfield may provide an indication of a TWT flow, according to three bits of the subfield, with any other bits reserved or tasked for other purposes. In the case of a bTWT, the subfield may provide an identifier of a bTWT group (e.g., one of 32 groups according to five bits of the subfield, with any other bits reserved or tasked for other purposes). In the case of a stream classification service identifier (SCSID), the subfield may provide drift information for a particular SCS stream. Further ID values can embed information relating to other aspects of TWT drift, such as TWT schedule ID for multi-AP coordination (e.g., to maintain temporal alignment between multiple BSS employing spatial reuse, mutually exclusive scheduling or otherwise managing access to a shared wireless medium).

The drift sign subfield 704 can indicate whether data availability (e.g., frame timing) leads or lags a scheduled SP. For example, where data is available prior to a start of a SP, the data may be described as leading the SP (or conversely, the SP may be described as lagging the data availability). In some embodiments, the drift sign subfield 704 can include a binary indication of phase lead or lag. In some embodiments, the sign can indicate a position of the SP relative to the data availability, such that one sign (e.g., cleared bit, or “0”) indicates that shifting back the SP can reduce an offset and another sign (e.g., set bit, or “1”) indicates that shifting forward the SP can reduce an offset. In some embodiments, the sign may indicate a direction of an adjustment itself (the adjustment being opposite of the offset, to reduce the magnitude of the offset).

The drift subfield 706 may include a scalar indication of drift. For example, the scaler can relate to a number of mS or μS per adjustment such as per frame, or per period. Such a period may refer to a temporal period and/or a number of SP/frames. In some embodiments, the period may be a predefined period (e.g., 1 second, 60 frames, or so forth). In some embodiments, the period may be variable according to another subfield, such as the adjustment interval subfield 710, described below. For example, for a 60 Hz frame rate, a drift may be provided as 20 μs (the ⅓ μs per frame multiplied by 60 frames). The drift subfield 706 may include an integer or floating point value according to various embodiments. In some embodiments, the drift subfield 706 may be implemented to include nine bits, or a greater or lesser number of bits, according to a particular implementation.

The adjustment interval unit subfield 708 may include an indication of a number of units for an adjustment. For example, the adjustment interval unit subfield 708 can include an indication of a unit type for the adjustment interval subfield 710. In some embodiments, the adjustment interval unit subfield 708 can include a binary indication between two adjustment units (e.g., microseconds/SP, milliseconds/microseconds, etc.).

The adjustment interval subfield 710 may indicate or include an adjustment interval in which the adjustments for drift are defined above are to be performed. The adjustment interval can provide an interval between adjustments, such as a number of SP or temporal spacing between adjustments. For example, an adjustment interval of 1 seconds, 10 seconds, 1000 SP, and so forth may be provided. Referring again to the previous example of a 60 Hz frame rate, to maintain an offset that does not exceed 10 μs, an adjustment interval subfield 710 may indicate a value of 500 ms or 30 SP. To maintain an offset that does not exceed 50 μs, an adjustment interval subfield 710 may indicate a value of 2.5s or 150 SP. In some embodiments, the adjustment interval subfield 710 may be provided as an octet (8 bits).

The frame rate present indication subfield 712 may include or identify an indication of the presence of a frame rate in the frame 700. For example, the indication can be provided as a binary indication (e.g., where a ‘1’ depicts an availability of a frame rate and a ‘0’ depicts an unavailability of a frame rate). Correspondingly, the frame rate subfield 714 itself can provide a frame rate according to an integer value, floating point value, or a predefined list of mapped values (e.g., 24 FPS, 29.97 FPS, 30 FPS, 59.94 FPS, 60 FPS, 75 FPS, 90 FPS, 120 FPS, 144 FPS, etc.). A drift can be determined based on the frame rate. For example, a device sending or receiving a frame rate of 120 FPS can determine that the drift for each SP/frame is ⅓ μS lagging, that an offset of 40 μS will accumulate over a second/120 SP, that after 300 SP, an offset of 100 μS will accumulate, or so forth.

In some embodiments or instances, at least some fields may be unpopulated, omitted, or modified. For example, a frame rate present indication subfield 712 may be omitted, wherein the population or population of the frame rate subfield 714 may be identified according to a non-zero or zero value thereof. A drift subfield 706 or adjustment interval subfield 710 can be omitted in an embodiment including a frame rate subfield 714 (e.g., where the interval is predefined, such as every frame or every integer offset). A drift subfield 706 or frame rate subfield 714 can be omitted in an embodiment including an adjustment interval subfield 710 (e.g., where the adjustment amount is predefined). An adjustment interval subfield 710 or frame rate subfield 714 can be omitted in an embodiment including a drift subfield 706 (e.g., wherein an interval is predefined).

FIG. 8 is a diagram showing an example frame structure for a drift information element 800 to convey drift information between various networked devices, according to an example implementation of the present disclosure. The drift information element 800 includes an element ID 802 to identify the element as a drift information element 800. For example, a predefined bit pattern can identify the frame type relative to other management frames. A length subfield 804 can provide a length of the further portions of the drift information element 800 (e.g., exclusive and/or inclusive of the element ID 802 and/or length subfield 804). The element ID extension subfield 806 can include an extension to the octet of the element ID 802 to further specify the contents of the drift information element 800.

A control subfield 808 can include control data/information/fields/bits for the drift information. For example, the control subfield 808 can include a drift sign subfield 704, adjustment interval unit subfield 708, frame rate present indication subfield 712, or reserved bit subfields 716, as described above with regard to FIG. 7. Additional or fewer subfields may be included in the control subfield 808 according to various embodiments. The drift information element 800 can further include a schedule/interval ID 702 subfield, drift subfield 706, adjustment interval subfield 710, and frame rate subfield 714 as described above with regard to FIG. 7.

In further embodiments, any number of the subfields of FIG. 7 or 8 can be provided in further elements, including a quality of service (QoS) characteristics element such as a stream classification service (SCS) descriptor element (e.g., as optional sub elements appended thereto), or a TWT setup frame. For example, the SP drift information may be provided subsequent to (e.g., immediately subsequent to) one or more TWT information elements.

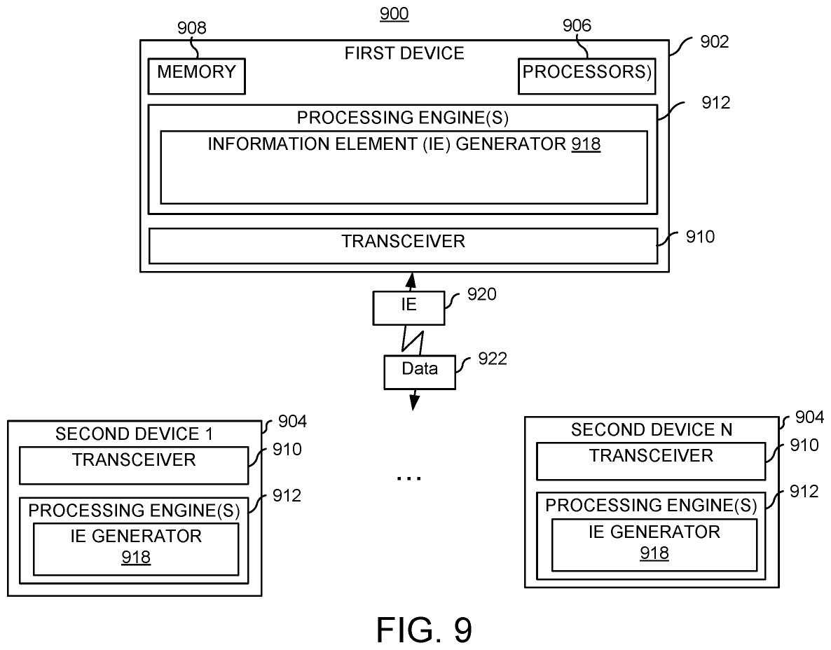

Referring now to FIG. 9, depicted is a block diagram of a computing environment 900, according to an example implementation of the present disclosure. The computing environment 900 includes systems for target wake time schedule management. The systems may include a first device 902 and any number second devices 904 (referred to generally as a second device 904). Either of the first device 902 or any of the second devices can include an AP 105 or a non-AP STA. The first device 902 and at least a subset of the second devices 904 may be associated with a same TWT distribution schedule (e.g., for an rTWT). The first device 902, like the second device 904, may include one or more processors 906 and memory 908, which may be similar, respectively, to the processor(s) 118/170 or processing units 316 and storage 318 described above with reference to FIG. 1-FIG. 3. The first device 902 and second device 904 may include respective wireless local area network (WLAN) transceivers 910 and processing engine(s) 912. The wireless local area network (WLAN) transceivers 910 may be similar to the communication interface(s) 115, 165 and the processing engine(s) 912 may be similar to the processing unit(s) 316, described above with reference to FIG. 1-FIG. 3.

As described in greater detail below, the first device 902 may include IE generators 918 configured to generate/establish information elements (IE) 920 for transmission (in a message) to the second device(s) 904. The IE 920 may convey TWT parameters between the first device 902 and second device(s) 904, such as to establish a TWT, confirm the establishment of the TWT, or adjust the established TWT SP. The first device 902 may be configured to transmit, send, communicate, or otherwise provide the IE 920 to the second device 904. The second device 904 may be configured to transmit, send, communicate, or otherwise provide further IE(s) 920 to the first devices 902. The first device 902 (and/or second devices 904) can be a TWT scheduled device and/or TWT scheduling device.

The first device 902 may be configured to generate/establish payload data 922 for transmission (in a message) to the second device(s) 904. The payload data 922 may convey latency sensitive information, such as frame data for provision to a HWD 150 of a VR/AR system. The first device 902 may be configured to transmit, send, communicate, or otherwise provide the IE 920 to the second device 904. In some embodiments, the second device 904 may be configured to generate/establish payload data 922 for transmission to the first device 902, or to transmit, send, communicate, or otherwise provide further payload data 922 to the first devices 902. In some embodiments, one or more of the second devices 904 can perform any of the operations disclosed as performed by the first device 902 (e.g., conveyance of drift information), and the first device 902 can perform any of the operations disclosed as performed by any of the second devices 904.

The first device 902 and second device 904 may support TWT functionalities/tasks/functions for communication during a session between the devices 902, 904. The sessions can include scheduling according to a granularity, such as a one ps or a 1024 μs TU. Such scheduling can be performed with of the first device 902 or the second device 904 as a TWT scheduling device. In various implementations, the first device 902 can generate payload data 922 that does not align with the granularity of the scheduled SP (e.g., latency sensitive periodic frame data). The first device 902 may support a conveyance of drift information to align a scheduled SP with such periodic data (or to manage other drift sources, such as for oscillator drift compensation).

The first device 902 may be configured to communicate, transmit, send, or otherwise provide the IE 920 to the second device 904. In some embodiments, the first device 902 may be configured to provide the IE 920 to the second device 904 via the respective transceivers 910. The various IE 920 may be embedded into a frame, packet, or other message. For example, the IE 920 may be encoded according to a predefined bit sequence of a transmission. Thus, references, herein, to messages, frames, or other data (e.g., indications) exchanged between the first device 902 and second devices 904 may refer to the provision of a message including an IE 920. For example, the first device 902 can provide drift information according to one or more IE 920 structured according to the disclosures corresponding to FIG. 8, FIG. 9, or as otherwise provided herein.

The first device 902 can adjust a start time of an SP incident to the provision of the drift information to the second device 904. For example, the first device 902 can adjust a start time of the SP to coincide with an availability of information which corresponds to a regular period (e.g., frame rate data for a HWD 150). Based on the adjustment of the SP, the first device 902 may maintain its transceiver 910 in a sleep state, or otherwise employ the transceiver 910 (e.g., to access a wireless medium of another network, or another TWT SP of a same network). For example, for a deferred SP start, the first device 902 can defer waking the transceiver 910.

The second device 904 may be configured to receive the IE 920 from the first device 902. Where multiple second devices 904 are in an environment (e.g., a BSS or subset thereof associated with a SP), each second device 904, or one of the second devices 904, may receive the IE 920 from the first device 902. The second device(s) 904 may be configured to receive the IE 920 via the transceiver 910. The second device 904 may be configured to respond to the IE 920 (e.g., to accept various configurations of the IE 920, to modify various configurations, etc.) as part of a handshake with the first device 902. In some embodiments, any of the second devices 904 may be configured to adjust a time of a SP responsive to a receipt of the IE 920 including the drift information. For example, a second device 904 can adjust a start time of an SP to align with a data availability indicated in the drift information. In some embodiments, the second device 904 can implement the adjustment without providing an additional IE 920 back to the first device 902 incident to such adjustments. For example, the second device 904 can acknowledge a receipt of an IE920 providing the drift information, and thereafter implement periodic adjustments to SP start times 402 without further indications to the first device 902. Such implementations may reduce signaling overhead between the respective devices 902, 904.

The second device 904 can, responsive to the adjustment of the SP, delay or advance an active state for a transceiver 910 thereof. The deferral may reduce an active period to reduce power usage by the second device 904. The advancement may help the second device 904 to receive latency sensitive data earlier than for a previously scheduled start time for the SP, such that latency may be reduced (e.g., where the first device 902 and second device 904 adjust the SP a same amount, according to the drift information provided to the second device 904 by the first device 902). Moreover, such a deferral may extend an effective duration 606 by providing additional SP duration subsequent to data availability.

In some embodiments, one or more of the second devices 904 can adjust an SP which is different from the SP carrying the periodic data. Such an adjustment may be in addition to the SP carrying the periodic data or, may be instead of such an SP (e.g., where the second device 904 is not a member of the SP carrying the periodic data, as in the case of an rTWT). For example, the second devices 904 can adjust an SP temporally abutting the SP intended for conveyance of the periodic data to prevent temporal overlap, or to maintain an inter-SP gap (e.g., so that a gap is not less than a short interframe space (SIFS)). In some embodiments, the second device 904 can reduce an inter-SP gap and maintain another scheduled SP. For example, the second device can compare an adjusted gap to a predefined interframe spacing (e.g., the SIFS, or another value, such as zero, to prevent transmission overlap) and reduce the gap responsive to determining that the adjustment would not violate the predefined interframe spacing.

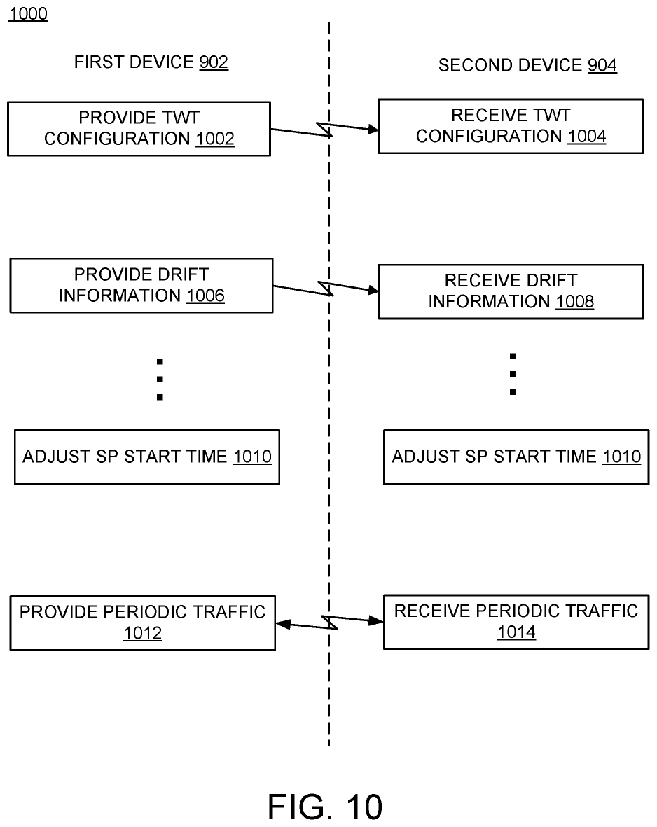

Referring now to FIG. 10, depicted is an interaction diagram or flowchart showing an example method 1000 for managing TWT schedules, according to an example implementation of the present disclosure. The method 1000 may be performed by various devices, components, or elements described above with reference to FIG. 1-FIG. 9. In some embodiments, some steps, operations, or processes of the method 1000 may be performed by one device (such as the first device 902), and other steps or processes of the method 1000 may be performed by another device (such as the second device 904). Either of the first device 902 or the second device 904 can include an AP 105 and another of the first device 902 or the second device 904 can include a STA. In some embodiments, more than one second device may be present. In some embodiments, some aspects of the method 1000 are performed with respect to further devices. For example, a TWT schedule for one or more SP can be communicated to multiple (e.g., all) devices of a BSS, or another BSS sharing at least a portion of a wireless medium.

At operation 1002, a first device 902 may generate one or more first IE(s) 920 configured to define a TWT configuration. For example, the first device 902 can provide an indication in a broadcast frame, such as a beacon frame, to one or more second devices 904, or an individual TWT to a particular second device 904. In some embodiments, the first IE 920 can be provided incident to negotiation between the first device 902 and second device(s) 904. For example, an AP 105 can assign the TWT parameters for one or more STA for a TWT Wake Interval (e.g., time between successive TWT SP), corresponding to the SP interval 406 of FIG. 4, TWT Wake Duration (e.g., how long the device stays awake), corresponding to the duration 404 of FIG. 4, and TWT Offset (e.g., the time offset for the start of the TWT SP). In some embodiments, the TWT configuration provided by the first device 902 can include a response to (e.g., confirmation of) such parameters. The various SP defined according to the TWT parameters can be provided according to a granularity specified for the IE 920. For example, a bTWT can provide an SP interval 406 according to an integer number of TU; an iTWT can provide an SP interval 406 according to an integer number of ps. The second device 904 can receive the one or more IE 920 indicative of the TWT configuration at operation 1004. For example, the second device 904 can receive a first indication of a TWT SP in a beacon frame from an AP 105 indicating that a BSS is a TWT enabled BSS.

At operation 1006, a first device 902 may provide drift information. In some embodiments, operation 1006 may coincide with operation 1002. For example, the drift information may be provided along with TWT configuration, such as via one or more TWT elements. In some embodiments, the drift information may be provided subsequent to the provision of the TWT configuration at operation 1002. For example, the drift information can be provided in a separate drift information element 800, or another element such as a QoS characteristics element (e.g., an SCS descriptor element). The second device 904 can receive the drift information at operation 1008. The receipt of the drift information can include additional processing to determine any adjustments corresponding thereto. For example, the second device 904 can receive an amount of drift per interval, adjustment interval, frame rate, oscillator phase-lag, or so forth, and determine an adjustment corresponding thereto.

At operation 1010, the first device 902 and the second device 904 can adjust a start time for a SP scheduled according to the TWT configuration of operation 1002 and the drift information of operation 1006. The respective devices 902, 904 can perform operation 1010 at a same or different time. For example, the adjustment can be performed, by the first device 902 prior to the provision of the drift information at operation 1006, and by the second device 904 subsequent to (e.g., responsive to) a receipt of the drift information. The adjustment can refer to or include an adjustment to an active period for a transceiver, a scheduled interrupt, or other queue management function. For example, the first device 902 or the second device 904 can cause a transceiver to enter active state earlier or later to effect/make/implement the adjustment. In some embodiments, operation 1010 can further include the adjustment of further SP, such as to prevent temporal overlap between an adjusted SP and an abutting unadjusted SP. Such adjustments can include adjustments by a second device which is not configured to receive the periodic data, or which is not a member of the same BSS, according to various management schemes for a wireless medium.

At operation 1012, the first device 902 can provide periodic traffic (e.g., frame data) to the second device 904. The periodic traffic is received, by the second device 904 at operation 1014. The provision of the periodic traffic may exhibit improved synchronicity/synchronization with the adjusted SP relative to the unadjusted SP. For example, in some embodiments, the periodic traffic may be provided immediately upon the availability of data for transmission. In some embodiments, the adjusted SP may not coincide exactly with an availability of data (e.g., according to jitter of the periodic data, or non-integer remainders in an offset which an adjustment does not compensate for). However, even in such embodiments, an offset between the availability of the periodic data and the adjusted SP may be reduced, at least relative to the unadjusted SP. In some embodiments, operations 1010 and 1012-1014 may be performed periodically, according to the drift information (e.g., a period provided in, or derived from, the drift information). Indeed, any of the various operations of FIG. 10 can be repeated or performed in various sequences. For example, the operation can be performed with regard to TWT configurations corresponding to multiple SP, such as multiple SP between same devices, or different SP corresponding to different network devices.

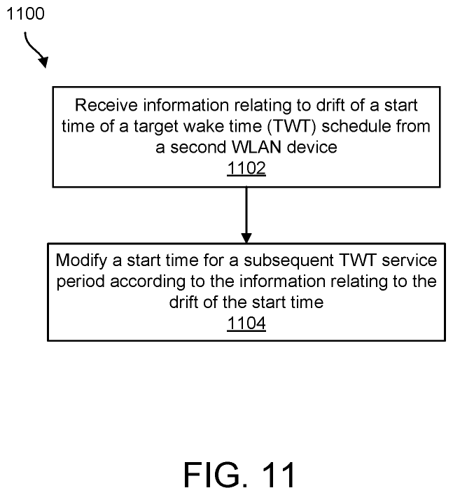

Referring now to FIG. 11, depicted is a flowchart showing an example method 1100 for management of at least one service period schedule, according to an example implementation of the present disclosure. The method 1100 may be performed by various devices, components, or elements described above with reference to FIG. 1-FIG. 10. For example, all or some steps, operations, or processes of the method 1100 may be performed by a first device 902. In some embodiments, steps, operations, or processes of the method 1100 may be performed by another Wi-Fi direct client or other non-AP device, or in conjunction with an AP device. In some embodiments, the first device 902 includes one of an AP 105 or a (non-AP) STA, and the second device 904 includes the other of an AP 105 or a STA.

At operation 1102, the first device 902 may receive information relating to the drift of a start time of a target wake time (TWT) schedule from a second WLAN device. The information relating to the drift can include a drift sign to indicate whether the start time leads or lags in time relative to an availability of data for transmission. For example, such information can be provided as a drift sign subfield 704, as described with regard to FIG. 7 and FIG. 8. The information relating to the drift can include a drift value indicating an amount of drift (e.g., per interval 406, per adjustment, etc.). For example, the drift value can be provided as a drift subfield 706, as described with regard to FIG. 7 and FIG. 8. The information relating to the drift can include an adjustment value to indicate an amount of an adjustment (e.g., per interval 406, per adjustment, etc.). For example, the adjustment value can be provided as an adjustment interval subfield 710 as described with regard to FIG. 7 and FIG. 8. In some embodiments, the adjustment value is separate from the drift value. For example, the drift and adjustment values can be provided for different periods. The information relating to the drift can include a frame rate or other indication of data periodicity. For example, the frame rate can be provided as a frame rate subfield 714, as described with regard to FIG. 7 and FIG. 8.

The information relating to the drift can be received in one or more messages, or IE(s) 920 thereof. The information relating to the drift can be received in a message including other TWT information. In some embodiments, information relating to the drift is received in a TWT setup frame, which includes one or more TWT elements. In some embodiments, the information relating to the drift is received in a same message as a TWT element indicating a start time and a wake interval of the TWT schedule. In some embodiments, the information relating to the drift can be received in a message including a quality of service (QoS) characteristics element. For example, the message can include an SCS descriptor element (e.g., the information relating to the drift can be appended to the SCS descriptor elements as a trailing optional sub element).

In some embodiments, the information relating to the drift is received in an announcement of the TWT schedule from the second WLAN device. Such a message can be received as a broadcast or individually addressed frame. In some embodiments, the announcement may include a broadcast frame such as a beacon response frame or a probe response frame. In some embodiments, the announcement may include an individually addressed frame to the first device, such as an individual probe response frame or a re-association response frame.

At operation 1104, the first device 902 may modify a start time for a subsequent TWT service period, according to the information relating to the drift of the start time from the second WLAN device. For example, the first device 902 may modify the start time for a SP to coincide with the availability of data for transmission. The modification of the start time can be common between the first device 902 and second device 904, such that the adjusted SP can be aligned between the first device 902 and the second device 904. In some embodiments, the modification of the TWT service period can include a modification of further SP, such as to avoid temporal overlap. Such adjustments can be performed at any of the first device 902, the second device 904, or any further devices in network communication therewith.

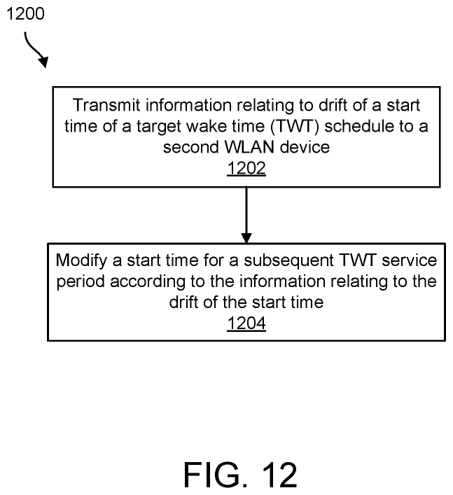

Referring now to FIG. 12, depicted is a flowchart showing an example method 1200 for service period schedule management, according to an example implementation of the present disclosure. The method 1200 may be performed by various devices, components, or elements described above with reference to FIG. 1-FIG. 11. For example, all or some steps, operations, or processes of the method 1200 may be performed by a second device 904. In some embodiments, steps, operations, or processes of the method 1200 may be performed by or in conjunction with further devices. In some embodiments, the first device 902 of the present method may be the second device 904 of the method 1100 of FIG. 11 (and vice versa). The first device 902 of the present method may perform the present method 1200 simultaneously, and in conjunction with, the device performing the method 1100 of FIG. 11. For example, the respective modifications to the start times may be to align the start time to an availability of data.

At operation 1202, the first device 902 may transmit information relating to drift of a start time of a target wake time (TWT) schedule to a second WLAN device. The information can include any of the information discussed with regard to operation 1102 of the method of FIG. 11, or as otherwise provided for herein (e.g., at FIG. 7 and FIG. 8). For example, in some embodiments, the information relating to the drift is transmitted in a message including a TWT element indicating a start time and a wake interval of the TWT schedule.

At operation 1204, the first device 902 may modify a start time for a subsequent TWT service period, according to the information relating to the drift of the start time. In some embodiments, the modification of the start time can align (or reduce a magnitude of misalignment) between the first device and one or more second devices. As such, operation 1204 may be similar to operation 1104 of FIG. 11, but performed by the first device 902.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations. The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
receiving, by a first device of a wireless local area network (WLAN), information relating to drift of a start time of a target wake time (TWT) schedule from a second device of the WLAN; and
modifying, by the first device, a start time for a subsequent TWT service period, according to the information relating to the drift of the start time from the second device.

2. The method of claim 1, wherein the first device receives the information in an announcement of the TWT schedule from the second device.

3. The method of claim 2, wherein the announcement comprises at least one of a broadcast frame, the broadcast frame comprising a beacon response frame or a probe response frame, or an individually addressed frame to the first device, the individually addressed frame comprising an individual probe response frame or a re-association response frame.

4. The method of claim 1, wherein the information relating to the drift is received in a message comprising a TWT element indicating a start time and a wake interval of the TWT schedule.

5. The method of claim 1, wherein the information relating to the drift is received in a message comprising a quality of service (QoS) characteristics element.

6. The method of claim 1, wherein the first device comprises at least one of an access point (AP) or a station device (STA), and wherein the second device comprises a different one of the AP or the STA.

7. The method of claim 1, wherein the information relating to the drift of the start time comprises at least one of: a drift sign, a drift value, or an adjustment value.

8. The method of claim 7, wherein the information further comprises a frame rate.

9. The method of claim 1, wherein the information relating to the drift of the start time is carried in a TWT setup frame, which further comprises one or more TWT elements.

10. A first device, comprising:
a transceiver for operating in a wireless local area network (WLAN); and
one or more processors configured to:
receive, via the transceiver, information relating to drift of a start time of a target wake time (TWT) schedule from a second device; and
modify a start time for a subsequent TWT service period, according to the information relating to the drift of the start time from the second device.

11. The first device of claim 10, wherein the first device receives the information in an announcement of the TWT schedule from the second device.

12. The first device of claim 11, wherein the announcement comprises at least one of a broadcast frame, the broadcast frame comprising a beacon response frame or a probe response frame, or an individually addressed frame to the first device, the individually addressed frame comprising an individual probe response frame or a re-association response frame.

13. The first device of claim 10, wherein the information relating to the drift is received in a message comprising a TWT element indicating a start time and a wake interval of the TWT schedule.

14. The first device of claim 10, wherein the information relating to the drift is received in a message comprising a quality of service (QoS) characteristics element.

15. The first device of claim 10, wherein the first device comprises at least one of an access point (AP) or a station device (STA), and wherein the second device comprises a different one of an AP or a STA.

16. The first device of claim 10, wherein the information relating to the drift of the start time comprises a drift sign, a drift value, and an adjustment value.

17. The first device of claim 16, wherein the information further comprises a frame rate.

18. The first device of claim 10, wherein the information relating to the drift of the start time is carried in a TWT setup frame, which further comprises one or more TWT elements.

19. A method, comprising:
transmitting, by a first device of a wireless local area network (WLAN), information relating to drift of a start time of a target wake time (TWT) schedule to a second device of the WLAN; and
modifying, by the first device, a start time for a subsequent TWT service period, according to the information relating to the drift of the start time.

20. The method of claim 19, wherein the information relating to the drift is transmitted in a message comprising a TWT element indicating a start time and a wake interval of the TWT schedule.
